(19) United States
(12) Patent Application Publication
(10) Pub. No.: US 2011/0104435 A1
(43) Pub. Date: May 5, 2011

(54) COMPOSITE ARTICLES OF CERAMIC AND PLASTIC AND METHOD FOR MAKING THE SAME

(75) Inventor: QIANG WANG, Shenzhen City (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/815,501

(22) Filed: Jun. 15, 2010

(30) Foreign Application Priority Data
Oct. 29, 2009 (CN) 200910309072.3

(51) Int. Cl. B32B 3/10; B28B 19/00; B28B 11/04; B28B 17/00

(52) U.S. Cl. 428/138; 264/269; 264/430; 264/109

(57) ABSTRACT

A composite article of ceramic and plastic is provided. The composite article comprises a ceramic substrate defining a receiving portion therein, and at least one plastic member made of thermoplastic resin positioned in the receiving portion.

### BACKGROUND

1. Technical field

The present disclosure relates to a composite article made of ceramic and plastic and method for making the same.

2. Description of related art

Plastic and ceramic are usually mechanically assembled to form composite articles for functional or decorative effect. However, the assembling process can be complex and costly.

Therefore, there is room for improvement within the art.

### BRIEF DESCRIPTION OF THE DRAWINGS

Many aspects of the present composite article of ceramic and plastic and method for making the same can be better understood with reference to the following drawings. The components in the various drawings are not necessarily drawn to scale, the emphasis instead being placed upon clearly illustrating the principles of the present composite article of ceramic and plastic and method for making. Moreover, in the drawings, like reference numerals designate corresponding parts throughout the diagrams.

FIG. 1 is a schematic view of a composite article according to an exemplary embodiment.

FIG. 2 is a schematic cross-section view of the composite article shown in FIG. 1 taken along line II-II.

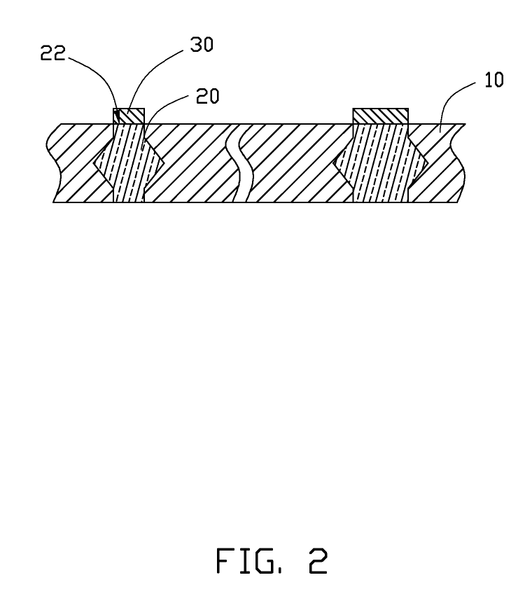

FIG. 3 is a schematic cross-section view of a ceramic substrate defining a receiving portion according to a first exemplary embodiment.

FIG. 4 is a schematic cross-section view of a ceramic substrate defining a receiving portion according to a second exemplary embodiment.

### DETAILED DESCRIPTION

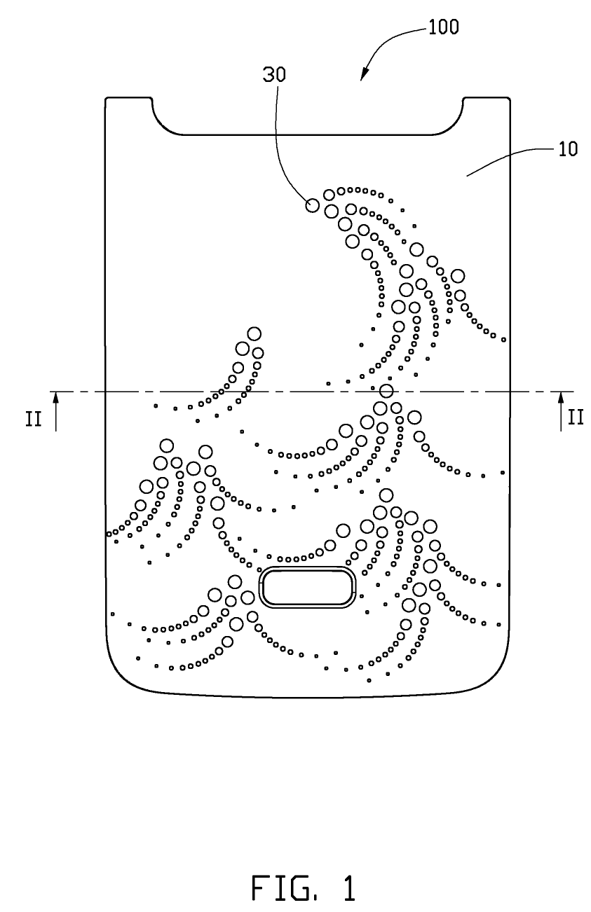

FIG. 1 shows an exemplary composite article 100, such as a housing for an electronic device. The composite article 100 includes a ceramic substrate 10 and at least one plastic member 20 positioned within the ceramic substrate 10.

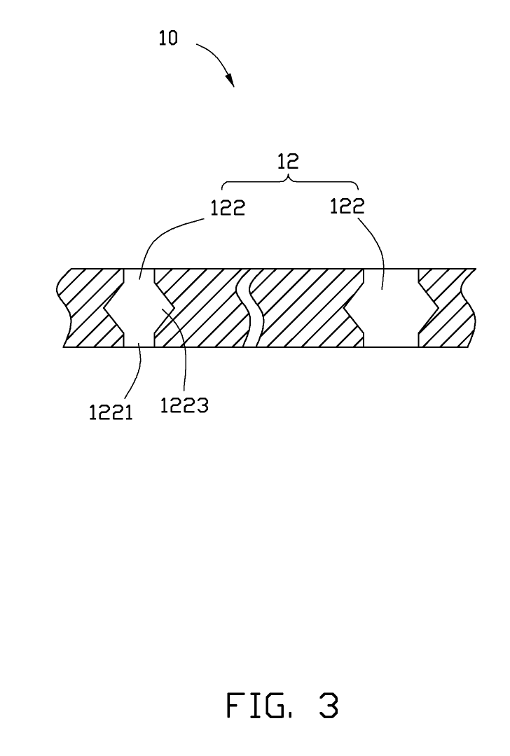

The ceramic substrate 10 can be made of reinforced ceramic and constitute a main portion of the composite article 100. Referring to FIG. 3, the ceramic substrate 10 defines a receiving portion 12 for receiving the plastic member(s) 20. The receiving portion 12 can be comprised of at least one hole 122 defined through the ceramic substrate 10. Each hole 122 has a broad portion 1223 between and wider than the two ends 1221 of the hole 122. The receiving portion 12 can be comprised of a plurality of through holes 122. The holes 122 need not be all the same size but can come in a variety of shapes and sizes. The receiving portion 12 may be designed for aesthetic and/or informative purposes depicting various patterns or symbols.

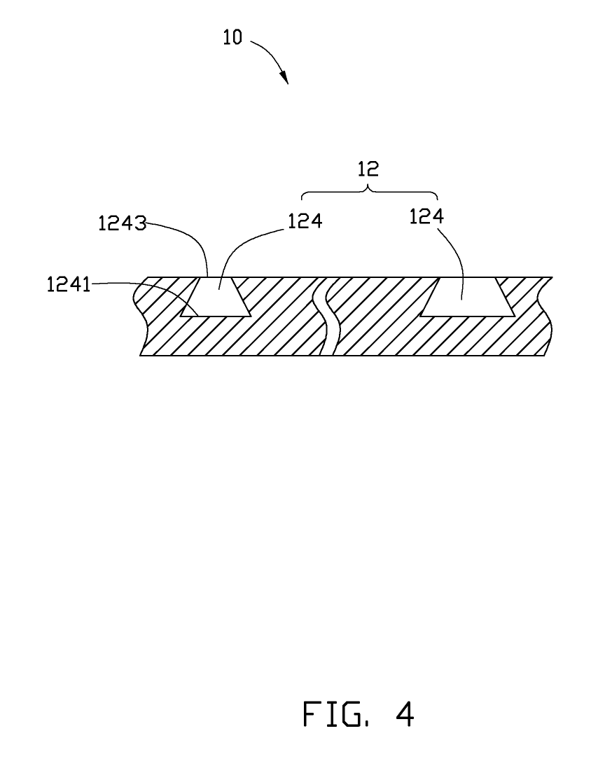

Referring to FIG. 4, in the second exemplary embodiment, the receiving portion 12 also can be composed of at least one recess 124 formed on the ceramic substrate 10. The bottom 1241 of the recess 124 is wider than the top 1243 of recess 124.

The plastic member(s) 20 is received in the receiving portion 12. The plastic member(s) 20 and the ceramic substrate 10 can be integrally formed by insert molding. The plastic member(s) can form decorative patterns or symbols on the ceramic substrate 10. When the plastic member(s) 20 is made of a plastic which can be electroplated, for example, acrylonitrile-butadiene-styrene (ABS), polycarbonate (PC), and polyethylmethacrylate (PMMA), an electroplated coating 30 can be further formed on the exposed portions 22 of the plastic member 20, to achieve a metallic appearance.

An exemplary method for making the composite article 100 may include the following steps.

A preformed ceramic substrate 10 is provided. The ceramic substrate 10 can be formed by preforming a clay body of ceramic powder and adhesive and sintering the clay body. The ceramic substrate 10 includes the receiving portion 12. The receiving portion 12 can either be formed as part of the preforming of the substrate 10 or by machining after the sintering.

Thermoplastic resin is filled into the receiving portion 12 to form the plastic member(s) 20. Once cooled, the plastic member(s) 20 combines the ceramic substrate 10 to form the composite article 100. This step can be accomplished by insert molding.

When the plastic member(s) 20 is made of a plastic which can be electroplated, the electroplated coating 30 can be further formed on the exposed portions 22 to achieve a metallic appearance.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A composite article, comprising:
a ceramic substrate, the ceramic substrate defining an receiving portion therein; and
at least one plastic member made of thermoplastic resin positioned in the receiving portion.

2. The composite article as claimed in claim 1, wherein the receiving portion is comprised of at least one hole defined through the substrate.

3. The composite article as claimed in claim 2, wherein each hole has a broad portion between and wider than the two ends of the hole.

4. The composite article as claimed in claim 1, wherein the receiving portion is comprised of at least one recess formed on the substrate.

5. The composite article as claimed in claim 4, wherein the bottom of the at least one recess is wider then the top of the recess.

6. The composite article as claimed in claim 1, wherein the receiving portion depicts patterns or symbols.

7. The composite article as claimed in claim 1, wherein the composite article further includes an electroplated coating formed on the exposed portion of the plastic member.

8. The composite article as claimed in claim 1, wherein the plastic member is made of one of the acrylonitrile-butadiene-styrene, polycarbonate, and polyethylmethacrylate.

9. A method for making a composite article, comprising:
providing a preformed ceramic substrate, the substrate defining an receiving portion therein; and
filling thermoplastic resin into the receiving portion to form at least one plastic member in the receiving portion to form the composite article.

10. The method as claimed in claim 9, wherein the method further comprise forming an electroplated coating on the portion of the plastic member exposed out of the substrate.

11. The method as claimed in claim 9, wherein substrate is formed by preforming a clay body of ceramic powder and adhesive and sintering the clay body.

12. The method as claimed in claim 9, wherein the receiving portion is comprised of at least one recess formed on the substrate.

13. The method as claimed in claim 12, wherein the bottom of the at least one recess is wider then the top of the recess.

14. The method as claimed in claim 9, wherein the receiving portion is comprised of at least one hole defined through the substrate.

15. The method as claimed in claim 14, wherein each hole has a broad portion between and wider than the two ends of the hole.

16. The method as claimed in claim 9, wherein the receiving portion depicts patterns or symbols on the substrate.
